(19) United States
(12) Patent Application Publication
(10) Pub. No.: US 2022/0006201 A1
(43) Pub. Date: Jan. 6, 2022

(54) Ultra-broadband mode size converter based on an on-chip Luneburg lens

(71) Applicant: SHANGHAI JIAOTONG UNIVERSITY, Shanghai (CN)

(72) Inventors: Jian Shen, Shanghai (CN); Yong Zhang, Shanghai (CN); Yikai Su, Shanghai (CN)

(21) Appl. No.: 17/448,186

(22) Filed: Sep. 20, 2021

Related U.S. Application Data
(63) Continuation of application No. PCT/CN2021/096618, filed on May 28, 2021.

(30) Foreign Application Priority Data
Nov. 3, 2020 (CN) 202011208110.9

(51) Int. Cl. H01Q 15/08; H01Q 19/06

(52) U.S. Cl. CPC H01Q 15/08; H01Q 19/06

(57) ABSTRACT

The silicon waveguides consist of an input waveguide and an output waveguide, and the input and output silicon waveguides are arranged on the both sides of the Luneburg lens, respectively. The width of the input waveguide is larger than that of the output waveguide. The structure of the Luneburg lens is a metamaterial layer of the periodic silicon nanorod antenna array, which the upper cladding and the lower cladding are SiO₂. The required refractive index distributions by the Luneburg lens can be implemented through the metamaterial structure of the gradient index profiles.

### CROSS REFERENCES

This application is the US continuation application of International Application No. PCT/CN2021/096618 filed on 28 May 2021 which designated the U.S. and claims priority to Chinese Application No. CN202011208110.9 filed on 3 Nov. 2020, the entire contents of each of which are hereby incorporated by reference.

### TECHNICAL FIELD

The invention designs and fabricates an ultra-broadband mode size converter based on an on-chip Luneburg lens, which relates to a technology in the field of integrated photonics.

### BACKGROUND OF THE INVENTION

In the photonic integrated circuits, in order to achieve ultra-broad operation bandwidth and small insertion loss, it is necessary to design optical devices with compact footprints and high coupling efficiency. One of the important devices is the mode size converter.

The mode size converter is used to match the different mode sizes. It can convert the mode size to achieve low-loss coupling between waveguides of different widths.

Silicon-based photonic devices have the characteristics of strong mode field confinement and the advantages of being compatible with complementary metal oxide semiconductor (CMOS) processes, making them as an ideal choice for photonic integrated circuits.

### SUMMARY OF THE INVENTION

In view of the complex design of the existing tapered waveguide structures and the difficulty in the manufacturing for focused ion beam etching or gray-scale exposure technology, an ultra-broadband mode size converter based on an integrated Luneburg lens is proposed. The refractive index distributions required by the Luneburg lens are achieved by the gradient index structures based on the metamaterial, which is combined with the silicon waveguides. Finally, a matching of the mode size in the waveguides of different widths is realized.

The invention is implemented through the following technical solutions:

The invention includes: an integrated Luneburg lens, input and output silicon waveguides, where the input and the output waveguides are respectively arranged on both sides of the Luneburg lens.

The silicon waveguide includes: an input waveguide named first waveguide and an output waveguide named second waveguide.

The width of the first waveguide is greater than the width of the second waveguide.

The structure of the on-chip Luneburg lens is a metamaterial layer whose upper and lower cladding layers are both silicon dioxide, and the metamaterial layer is a silicon periodic nanorods array structure with gradient index profiles.

The Luneburg lens has a radial duty ratio distribution, and the refractive index distribution satisfies: n(R)=nₑ \sqrt{2−(R/Rₗₑₙₛ)²}, where: nₑ is the edge refractive index, Rₗₑₙₛ is the radius of the Luneburg lens, R is the radial distance from the center of the Luneburg lens, The length of the lens is L=2Rₗₑₙₛ.

The relationship between the maximum refractive index and the minimum refractive index in the Luneburg lens is nₘₐₓ=\sqrt{2}nₘᵢₙ, where nₘᵢₙ refers to the minimum refractive index value in the Luneburg lens, and nₘₐₓ, refers to the maximum refractive index value in the Luneburg lens.

The equivalent material refractive index of the Luneburg lens is nₘₑₜₐ(R)²=δ(R)·n_{Si}²+[1−δ(R)]·n_{SiO}_{₂}², where n_{meta(R)}, n_{Si} and n_{SiO2} are the refractive index of the equivalent material, silicon and silicon dioxide, respectively, δ(R) is the duty cycle of the silicon nanorods array.

Results

The invention realizes the mode size conversion, coupling the light in the wide waveguide to the narrow waveguide in the silicon-based chip with extremely low loss. compared with the reported mode size converters, the mode size conversion can be achieved in the wavelength of 1.26 μm˜2 μm with the conversion loss of <1 dB, and a length of 11.2 μm, which exhibits excellent performance.

### BRIEF DESCRIPTION OF THE DRAWINGS

FIG. 1 is a schematic diagram of the structure of the proposed mode size converter.

FIG. 2 is a simulated transmission spectrum of the device.

FIG. 3 is a simulated spectrum at the wavelength of 1.55 μm for TE₀ mode.

FIG. 4 is a simulated spectrum at the wavelength of 1.26 μm for TE₀ mode.

FIG. 5 is a simulated spectrum of at the wavelength of 2 μm for TE₀ mode.

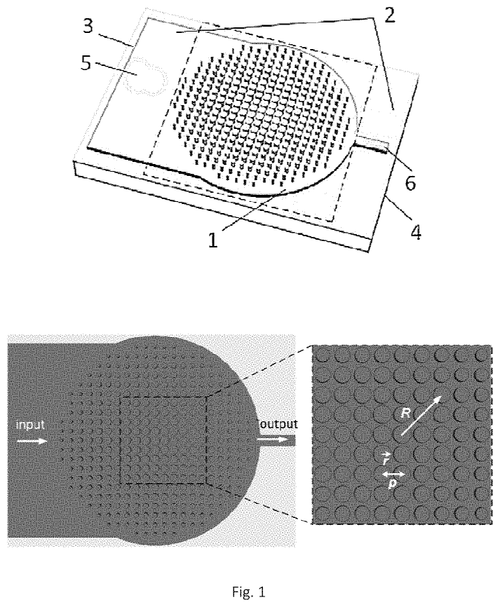

In the FIG. 1, an integrated Luneburg lens is marked 1, silicon waveguide is marked 2, input position is marked 3, output position is marked 4, first waveguide is marked 5, second waveguide is marked 6.

### DETAILED DESCRIPTION

As shown in FIG. 1, this solution relates to an ultra-broadband mode size converter based on an integrated Luneburg lens, which can be implemented on a SOI platform, including: an integrated Luneburg lens 1 and the silicon waveguide 2, the input position 3 and the output position 4, where the input position 3 and the output position 4 are arranged on both sides of the Luneburg lens 1, respectively.

The silicon waveguide 2 includes: a first waveguide 5 and a second waveguide 6, where the first waveguide 5 is arranged on the input position 3, and the second waveguide 6 is arranged on the output position 4.

The structure of the Luneburg lens 1 is a metamaterial layer with both upper and lower cladding layers of silicon dioxide, where the metamaterial layer is a silicon periodic nanorod array with gradient index profiles, and the effective refractive index depends on the duty cycle of the silicon nanorods array. The period of the nanorods is P. The metamaterial layer realizes the function of the Luneburg lens, reducing the footprint with low loss.

The width of the first waveguide 5 and the diameter of the Luneburg lens 1 can be adjusted according to practical applications.

The width of the first waveguide 5 is greater than the width of the second waveguide 6, and the expansion ratio of the first waveguide 5 and the second waveguide 6 is 20:1, and the expansion ratio can be adjusted according to practical applications.

The Luneburg lens 1 has a radial duty cycle distribution, and the refractive index distribution satisfies n(R)=nₑ \sqrt{2−(R/Rₗₑₙₛ)²}, where nₑ is the edge refractive index, Rₗₑₙₛ is the radius of the Luneburg lens 1, and R is the radial distance from the center of the Luneburg lens 1. The length of Luneburg lens 1 is L=2Rₗₑₙₛ.

The relationship between the maximum refractive index and the minimum refractive index in the Luneburg lens 1 is nₘₐₓ=\sqrt{2}nₘᵢₙ.

The refractive index of the equivalent material of the Luneburg lens 1 is nₘₑₜₐ(R)²=δ(R)·n_{Si}²+[1−δ(R)]·n_{SiO}_{₂}², where n_{meta(R)}, n_{Si} and n_{SiO2} are the refractive indexes of the equivalent material, silicon and silicon dioxide, respectively. δ(R) is the duty cycle of the nanorods. The duty cycle ranges from 0 to 100%. Considering the feasibility of the experiment, the minimum duty cycle is set to 15%.

The solutions simulation relates to an ultra-broadband mode size converter, which includes the following steps:

Step 1: Set simulation parameters;

The thickness of the silicon layer on the SOI platform is 220 nm, the thickness of the buried oxide layer is 3 μm, and the thickness of the cladding silicon dioxide layer is 1 μm. The width of the first waveguide 5 and the second waveguide 6 are set to 10 μm and 0.5 μm, respectively. The minimum duty cycle of the nanorods is set to 15% so that the minimum effective refractive index is 1.84. The maximum duty ratio is set to 81% so that the maximum refractive index is 2.6. The period is 246 nm, and the length of the lens is L=2Rₗₑₙₛ=11.2 μm.

Step 2: Calculate the insertion loss and operation bandwidth according to the simulation parameters.

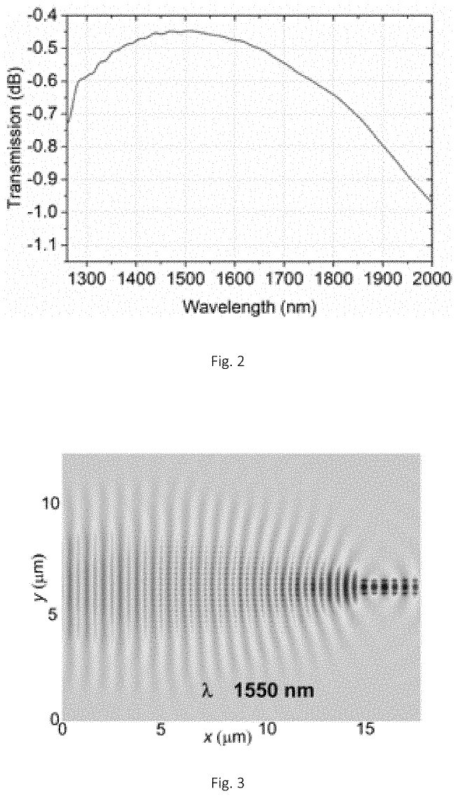

As shown in FIG. 2, the insertion loss is lower than 1 dB in the wavelength range of 1.26 μm to 2 μm. Therefore, the mode size converter has a 740 nm-bandwidth with low insertion loss.

Step 3: Changing the parameters of the first waveguide 5, the second waveguide 6 and the Luneburg lens 1, and calculating the effective refractive index of the TM fundamental mode under different wavelengths.

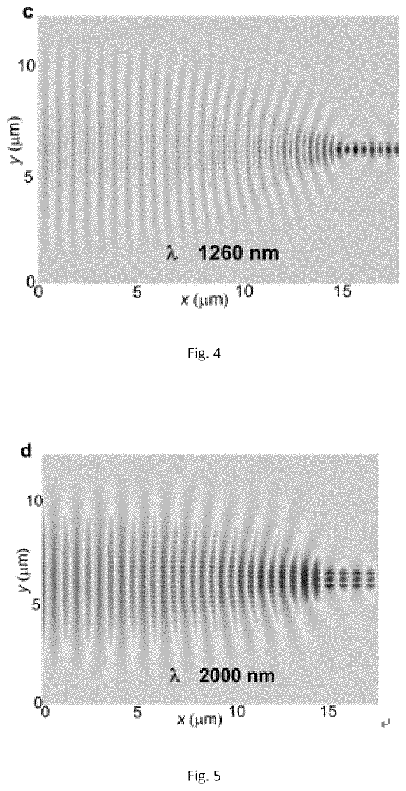

As shown in FIG. 3, FIG. 4, and FIG. 5, the distribution of the electric field (Ey) of the TE fundamental mode when the wavelength is 1.55 μm, 1.26 μm and 2 μm, respectively. Some parameters of the lens can also be adjusted to match with the effective refractive index of the TM fundamental mode, so that the conversion of the mode size for the TM fundamental mode can be achieved.

In the experiments, under normal room temperature, the C- and O-band laser are employed as input light source, the width of the first waveguide 5 and the second waveguide 6 are 10 μm and 0.5 μm, respectively. The minimum duty cycle of the nanorods is set to 15% so that the minimum effective refractive index is 1.84. The maximum duty cycle is set to 81% so that the maximum refractive index is 2.6. The period is 246 nm, the length of the lens is L=2Rₗₑₙₛ=11.2 μm. The mode size conversion is lower than 1 dB in the wavelength of 1260 nm˜1360 nm and 1507 nm˜1607 nm.

Compared with the reported mode size converter, this device can realize the conversion from 1.26 μm to 2 μm with a bandwidth of 740 nm, which is better than the performance of the existing taper structure. The conversion loss of the mode size is lower than 1 dB, which is better than the performance of the existing Hollow taper. The length of the device is 11.2 μm, and the footprint is more compact than a flat lens and other lens structures.

The above-mentioned specific implementations can be locally adjusted by different ways without departing from the principle and purpose of the invention. The protection scope of the invention is subject to the claims and is not limited by the above-mentioned specific implementations. All implementation schemes within the scope are bound by the invention.

What is claimed is:

1. An ultra-broadband mode size converter based on an on-chip Luneburg lens, including a Luneburg lens, an input waveguide and an output waveguide, where the input waveguide and the output waveguide are arranged at both sides of Luneburg lens, respectively. The silicon waveguide includes: an input waveguide and an output waveguide;
the structure of the Luneburg lens is a metamaterial layer with both upper and lower cladding layers of silicon dioxide, and the metamaterial layer is a silicon nanorod antenna array structure with gradient index profiles.

2. The ultra-broadband mode size converter according to claim 1, where the width of the first waveguide 5 is greater than the width of the second waveguide 6.

3. The ultra-broadband mode size converter according to claim 1, where the Luneburg lens has a radial duty ratio distribution, and the refractive index distribution satisfies n(R)=nₑ \sqrt{2−(R/Rₗₑₙₛ)²}, where nₑ is the edge refractive index, and Rₗₑₙₛ is the radius of the lens, R is the radial distance from the center of the Luneburg lens, and the length of the Luneburg lens is L=2Rₗₑₙₛ.

4. The ultra-broadband mode size converter according to claim 1, where the relationship between the maximum refractive index and the minimum refractive index is nₘₐₓ=\sqrt{2}nₘᵢₙ.

5. The ultra-broadband mode size converter according to claim 1, where the equivalent material refractive index of the Luneburg lens is nₘₑₜₐ(R)²=δ(R)·n_{Si}²+[1−δ(R)]·n_{SiO}_{₂}², where n_{meta(R)}, n_{Si} and n_{SiO2} are equivalent materials, silicon and silica, δ(R) is the duty cycle of the nanorods.
